(19) United States
(12) Patent Application Publication
(10) Pub. No.: US 2026/0288134 A1
(43) Pub. Date: Sep. 24, 2026

(54) INFORMATION PROCESSING DEVICE, CONTROL METHOD, AND NON-TRANSITORY COMPUTER READABLE MEMORY

(71) Applicant: Rakuten Group, Inc., Tokyo (JP)

(72) Inventor: Asaki MATSUMOTO, Tokyo (JP)

(73) Assignee: Rakuten Group, Inc., Tokyo (JP)

(21) Appl. No.: 19/070,687

(22) Filed: Mar. 5, 2025

(30) Foreign Application Priority Data
Mar. 26, 2024 (JP) 2024-049662

(51) Int. Cl. G05D 1/224; G05D 1/223; G05D 1/652; G05D 1/86; G05D 109/25; G05D 111/10

(52) U.S. Cl. CPC G05D 1/2248; G05D 1/2232; G05D 1/652; G05D 1/86; G05D 2109/254; G05D 2111/10

(57) ABSTRACT

The management server MS displays, on the drone monitoring screen through operator terminal Tm, the operation button for accepting the take-off clearance for the drone Dn from the operator OPm, and determines whether the judgment timing of the take-off clearance by the operator OPm has arrived. Then, the management server MS controls the operation button such that the take-off clearance is unacceptable from the operator OPm before the judgment timing of the take-off clearance arrives, and controls the operation button such that the take-off clearance is acceptable from the operator OPm when the drone Dn is in the flight-ready state after the judgment timing of the take-off clearance arrives.

### CROSS REFERENCE TO RELATED APPLICATION

This application claims priority from Japanese Patent Application No. 2024-049662 which was filed on Mar. 26, 2024, the disclosure of which is herein incorporated by reference in its entirety.

### TECHNICAL FIELD

One or more embodiments of the present invention relate to a technical field of a system in which an operator can monitor a plurality of unmanned aerial vehicles.

### RELATED ART

Conventionally, a flight management system for managing a flight of an unmanned aerial vehicle such as a drone is known. For example, a flight management system disclosed in JP 2020-24475 A calculates a pre-flight risk before the flight of the unmanned aerial vehicle, and outputs a processing result or receives an instruction via an input/output interface. This allows a flight manager or a manipulator (drone pilot) of the unmanned aerial vehicle to take action based on the pre-flight risk.

By the way, due to future service developments, for example, it is expected that one operator will make a take-off judgment in light of the pre-flight risk of each of the plurality of the unmanned aerial vehicles. In this case, since the burden on the operator will increase, it would be difficult for the operator to make appropriate take-off judgment in light of each pre-flight risk and there is a concern that human error will occur.

Therefore, one or more embodiments of the present invention are to providing an information processing device, a control method, and a non-transitory computer readable memory which are capable of preventing human error when the operator makes the take-off judgment.

### SUMMARY

(An aspect 1) In response to the above issue, an information processing device includes: at least one memory configured to store program code; and at least one processor configured to access the program code and operate as instructed by the program code. The program code includes: display control code configured to cause the at least one processor to display an operation button for accepting a take-off clearance for an unmanned aerial vehicle from an operator on a screen of a terminal used by the operator; first determination code configured to cause the at least one processor to determine whether a judgment timing has arrived, the judgment timing being a timing at which the operator is to judge whether to perform the take-off clearance; and button control code configured to cause the at least one processor to control the operation button such that the take-off clearance is unacceptable from the operator before the judgment timing arrives, and to control the operation button such that the take-off clearance is acceptable from the operator when the unmanned aerial vehicle is in a flight-ready state after the judgment timing arrives.
(An aspect 2) A control method executed by one or more computers, includes: displaying an operation button for accepting a take-off clearance for an unmanned aerial vehicle from an operator on a screen of a terminal used by the operator; determining whether a judgment timing has arrived, the judgment timing being a timing at which the operator is to judge whether to perform the take-off clearance; and controlling the operation button such that the take-off clearance is unacceptable from the operator before the judgment timing arrives, and to control the operation button such that the take-off clearance is acceptable from the operator when the unmanned aerial vehicle is in a flight-ready state after the judgment timing arrives.
(An aspect 3) A non-transitory computer readable memory has stored thereon a program configured to cause a computer to: display an operation button for accepting a take-off clearance for an unmanned aerial vehicle from an operator on a screen of a terminal used by the operator; determine whether a judgment timing has arrived, the judgment timing being a timing at which the operator is to judge whether to perform the take-off clearance; and control the operation button such that the take-off clearance is unacceptable from the operator before the judgment timing arrives, and to control the operation button such that the take-off clearance is acceptable from the operator when the unmanned aerial vehicle is in a flight-ready state after the judgment timing arrives.

### BRIEF DESCRIPTION OF THE DRAWINGS

FIG. 1 is a diagram illustrating a schematic configuration example of a remote monitoring system S.

FIG. 2 is a diagram illustrating a schematic configuration example of a drone Dn.

FIG. 3 is a diagram illustrating a schematic configuration example of an operator terminal Tm.

FIG. 4 is a diagram illustrating a display example 1 of a drone monitoring screen displayed on an operator terminal T1 of an operator OP1.

FIG. 5 is a diagram illustrating a display example 2 of a drone monitoring screen displayed on an operator terminal T1 of an operator OP1.

FIG. 6 is a diagram illustrating a display example 3 of a drone monitoring screen displayed on an operator terminal T1 of an operator OP1.

FIG. 7 is a diagram illustrating a display example 4 of a drone monitoring screen displayed on an operator terminal T1 of an operator OP1.

FIG. 8 is a diagram illustrating a display example 5 of a drone monitoring screen displayed on the operator terminal T1 of the operator OP1.

FIG. 9 is a diagram illustrating an example of a pop-up screen displayed when a take-off judgment button BO3 showing “TAKE-OFF SCHEDULED” is selected.

FIG. 10 is a diagram illustrating a schematic configuration example of a management server MS.

FIG. 11 is a diagram illustrating an example of functional blocks in a control unit 33.

FIG. 12 is a flowchart illustrating an example of a monitoring information display processing executed by the control unit 33 of the management server MS.

FIG. 13 is a flowchart illustrating an example of an abnormality determination processing executed by the control unit 33 of the management server MS.

### DETAILED DESCRIPTION

Hereinbelow, one or more embodiments of the present invention will be described with reference to the drawings. Incidentally, the following embodiment is an embodiment in a case where the present invention is applied to a remote monitoring system capable of remotely monitoring drones. Incidentally, in the above embodiment, the drone has been described as an example of the unmanned aerial vehicle, but the present invention is also applicable to a flying robot and the like as examples of the unmanned aerial vehicle.

### 1. Configuration and Operation Outline of Remote Monitoring System S

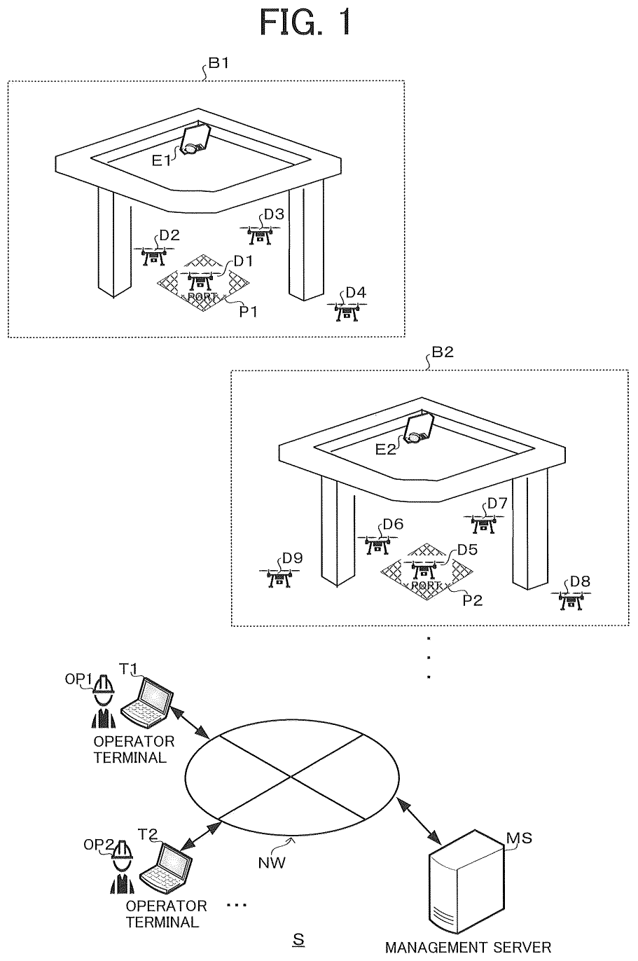

First, a description will be given as to a configuration and an operation outline of a remote monitoring system S according to the present embodiment with reference to FIG. 1. FIG. 1 is a diagram illustrating a schematic configuration example of the remote monitoring system S. As illustrated in FIG. 1, the remote monitoring system S includes a plurality of drones Dn (n=1, 2, 3, . . . ), a plurality of operator terminals Tm (m=1, 2, . . . ), and a management server MS (an example of an information processing device). The drone Dn, the operator terminal Tm, and the management server MS are each connected to a communication network NW. The communication network NW includes, for example, the Internet, a mobile communication network, a radio base station thereof, and the like.

The drone Dn is an example of an unmanned flying object, and is also referred to as a multicopter, or an UAV (Unmanned Aerial Vehicle). The drone Dn is capable of taking off according to take-off instructions from a GCS (Ground Control Station) and flying autonomously. The drone Dn is used for, for example, delivery, surveying, photographing, monitoring, and the like. The GCS is installed as an application in the operator terminal Tm, for example, and is configured to be cooperated with the management server MS. Incidentally, the drone Dn can also fly according to remote control from the ground by a manipulator terminal (installing the GCS) used by a manipulator (drone pilot).

The drone Dn is under the control (in other words, jurisdiction) of any one of a plurality of drone bases Bm (in other words, the drone Dn belongs to any drone base Bm). The drone base Bm is a base (e.g., a facility) where the drone Dn is allowed to take off or land. In the example of FIG. 1, each of the drones D1 to D4 is under the control of the drone base B1, departs (takes off) from the drone base B1, and returns (lands) to the drone base B1. Moreover, each of the drones D5 to D9 is under the control of the drone base B2, departs from the drone base B2, and returns to the drone base B2. However, one drone Dn may be under the control of the plurality of the drone bases Bm. For example, the drone D11 (not shown) may depart from the drone base B2 and return to the drone base B1. Incidentally, the number of drones Dn under the control of one drone base Bm is not particularly limited.

Moreover, in the drone base Bm, a port Pm used for a take-off and landing of drone Dn and a base instrument Em (an example of an instrument, a device, or an equipment) used for monitoring drone Dn are installed. At the drone base Bm, a base staff manually performs a pre-flight inspection (e.g., checking vehicle state or condition) of the drone Dn (hereinafter, the inspection is referred to as “manual inspection”). For example, the base staff visually inspects a predetermined portion of the drone Dn for each inspection item of the manual inspection, or inspects the predetermined portion of the drone Dn by touching it. Then, manual inspection result information (an example of base information) indicating the result of the manual inspection by the base staff is transmitted to the management server MS via the communication network NW from a terminal (an example of an instrument) such as a smartphone of the base staff. Moreover, the drone Dn, which has completed the pre-flight inspection, is placed at the port Pm and takes off (departs) from the port Pm according to a predetermined drone schedule. Moreover, the drone Dn that has returned to the drone base Bm lands at the port Pm. Incidentally, a plurality of ports Pm may be installed at one drone base Bm.

The base instrument Em is connected to the communication network NW, is equipped with a base camera (e.g., an RGB camera or an infrared camera) for monitoring the drone Dn. The base instrument Em stores a base ID (identification information) for identifying the drone base Bm. The base camera (an example of second camera) is configured to sequentially (continuously) capture (image) drone Dn placed, for example, at the port Pm. Base image information (an example of base information) representing base images (an example of second images, e.g., still images or moving images) captured by the base camera is transmitted from the base instrument Em to the management server MS together with the base ID. Incidentally, a plurality of base instruments Em may be installed at one drone base Bm. Moreover, the base instrument Em may be provided with a wind sensor that detects (measures) at least one of wind speed and wind direction. Measurement information (an example of base information) measured by the wind sensor is transmitted from the base instrument Em to the management server MS. Furthermore, the base instrument Em may be provided with at least one of a temperature sensor, a humidity sensor, a rainfall (snow) amount sensor, and an air pressure sensor (aerotonometer). Measurement information (an example of base information) measured by these sensors is transmitted from the base instrument Em to the management server MS.

The operator terminal Tm is a terminal used by an operator OPm who remotely monitors the plurality of the drones Dn. The operator OPm monitors the plurality of the drones Dn for which he/she is in charge while looking at information displayed on a screen (a user interface screen) of the operator terminal Tm. Such monitoring includes, for example, at least one of (i) checking the status of the pre-flight inspection of each of the plurality of the drones Dn, (ii) monitoring the condition of each of the plurality of the drones Dn before flight, (iii) monitoring the condition of each of the plurality of the drones Dn in flight. Moreover, the monitoring may include actions that involve monitoring (e.g., operations of operator OPm). The operator OPm judges on whether to perform a take-off clearance (in other words, take-off permission) before the drone Dn takes off. That is, the operator OPm makes a judgment (take-off judgment) on whether or not to permit the drone Dn to take off before the drone Dn takes off. Therefore, on the screen of the operator terminal Tm, a take-off judgment button (an example of an operation button) for accepting the take-off clearance for the drone Dn from the operator OPm is displayed. The take-off judgment button may be controlled such that the take-off clearance for the drone Dn is acceptable from the operator OPm only when the drone Dn is in a flight-ready (i.e., flyable) state after a judgment timing of the take-off clearance by the operator OPm arrives. The judgment timing is a timing at which the operator OPm is to judge whether to perform the take-off clearance. The control of the take-off judgment button includes, for example, control to enable or disable (i.e., activate or deactivate) the take-off judgment button. Incidentally, the control to disable the take-off judgment button may include display control to make the take-off judgment button gray out (i.e., making it difficult to see). The judgment timing may be set in multiple stages.

The management server MS is composed of one or a plurality of server computers that manages information on the drone base Bm for each drone base Bm. The information relating to the drone base Bm includes, for example, information on the drone Dn under the control of the drone base Bm, information on the operator OPm who monitors the drone Dn, and information on the operator terminal Tm used by the operator OPm. The management server MS identifies the plurality of the drones Dn for which the operator OPm who has logged in by operating the operator terminal Tm is in charge, and controls to displays a list (hereinafter referred to as “drone list”) showing the identified plurality of the drones Dn on the operator terminal Tm of the operator OPm. Moreover, the management server MS regularly or irregularly receives detailed weather information at the drone base Bm from a weather management server (not shown) via the communication network NW. The detailed weather information indicates the details of the weather.

### 1-1. Configuration and Function of Drone Dn

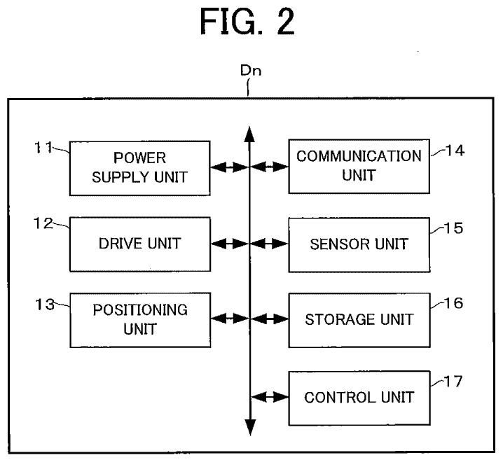

Next, a configuration and a function of the drone Dn will be described with reference to FIG. 2. FIG. 2 is a diagram illustrating a schematic configuration example of the drone Dn. As illustrated in FIG. 2, the drone Dn includes a power supply unit 11, a drive unit 12, a positioning unit 13, a communication unit 14, a sensor unit 15, a storage unit 16, a control unit 17, and the like. Furthermore, the drone Dn includes a propeller (a rotor), which is a horizontal rotary wing, an arm pipe (including an arm joint) for attaching the propeller to a drone main body (a housing), and the like. Incidentally, in a case where the drone Dn is used for delivery of an article, the drone Dn includes a holding mechanism or the like for holding the article.

The power supply unit 11 includes a detachable battery (an electric storage device) and the like. The power supply unit 11 supplies (supplies electricity) power stored in the battery to each unit of the drone Dn. Moreover, the power supply unit 11 sequentially measures a remaining battery capacity. Battery information indicating the remaining battery capacity measured by the power supply unit 11 is output to the control unit 17. The drive unit 12 includes a motor, a rotation shaft, and the like. The drive unit 12 rotates the plurality of rotors by a motor, a rotation shaft, and the like that are driven in accordance with a control signal output from the control unit 17.

The positioning unit 13 includes a radio wave receiver, an altitude sensor, and the like. The positioning unit 13 receives, for example, a radio wave transmitted from positioning satellites of a GNSS (Global Navigation Satellite System) such as a GPS (Global Positioning System) by a radio wave receiver, and sequentially detects, on the basis of the radio wave, a current position of the drone Dn. The current position of the drone Dn may be expressed by the latitude and longitude of the drone Dn, or by the latitude, longitude, and altitude of the drone Dn. Here, the positioning satellites may include satellites used by a plurality of satellite positioning systems, such as GPS (Global Positioning System) satellites, Michibiki (QZSS: Quasi-Zenith Satellite System) satellites, and Galileo satellites. Position information indicating the current position detected by the positioning unit 13 is sequentially output to the control unit 17. At this time, capture number information indicating the capture number (satellite capture number) of positioning satellites captured by the positioning unit 13 is sequentially output to the control unit 17. Incidentally, the positioning unit 13 may detect the altitude of the drone Dn by the altitude sensor. In this case, the position information indicating the current position of the drone Dn includes altitude information indicating the altitude detected by the altitude sensor. The communication unit 14 has an antenna and a wireless communication function, and is responsible for controlling communication performed via the communication network NW.

The sensor unit 15 includes various sensors used to control the drone Dn. Examples of the various sensors include a compass (a geomagnetic sensor), a gyro (a triaxial angular speed sensor), a triaxial acceleration sensor, an atmospheric pressure sensor, a gimbal, an optical sensor, a range finder (a distance meter), and the like. The optical sensor includes a vehicle (aircraft) camera (for example, an RGB camera and an IR (Infrared ray) camera) and the like. The vehicle camera (an example of a first camera) is configured, for example, to sequentially capture images of the surroundings of the drone Dn (for example, in front of or below the drone Dn). Incidentally, the direction of the vehicle camera (e.g., forward or downward of the drone Dn) can be controlled by the control unit 17. Sensing information sensed by the sensor unit 15 is output to the control unit 17. The storage unit 16 includes a nonvolatile memory or the like, and stores various programs and data. Moreover, the storage unit 16 stores a vehicle ID (identification information) for identifying the drone Dn.

The control unit 17 includes at least one CPU (Central Processing Unit), an ROM (Read Only Memory), an RAM (Random Access Memory), and the like, and controls the drone Dn on the basis of the position information from the positioning unit 13 and the sensing information from the sensor unit 15. Such control includes control of a rotation speed of a propeller, control of a position, a posture, and a traveling direction of the drone Dn, and the like. The position information (i.e., the position information from the positioning unit 13) of the drone Dn, vehicle image information (an example of vehicle information) representing vehicle images (still images or moving images (video)) captured by the vehicle camera, the battery information (an example of vehicle information) from the power supply unit 11, and the capture number information (an example of vehicle information) from the positioning unit 13 are transmitted to the management server MS via the communication network NW together with the vehicle ID of the drone Dn.

Moreover, the control unit 17 has a self-diagnosis function, and performs an automatic inspection for each inspection item on whether a predetermined portion (for example, the power supply unit 11, the drive unit 12, the positioning unit 13, the communication unit 14, the sensor unit 15, or the like) of the drone Dn normally operates. The inspection items of the automatic inspection include, for example, the remaining battery capacity, a battery cell balance, the GPS, the compass, the gyro, the acceleration sensor, the air pressure sensor (atmospheric pressure sensor), the gimbal, the optical sensor, the range finder, and the like. Automatic inspection result information indicating results of the automatic inspection by the drone Dn (that is, the control unit 17) is transmitted to the management server MS via the communication network NW. Incidentally, the automatic inspection by the drone Dn is performed before the drone Dn flies, but some inspection items of the automatic inspection are also performed during the drone Dn flies.

### 1-2. Configuration and Function of Operator Terminal Tm

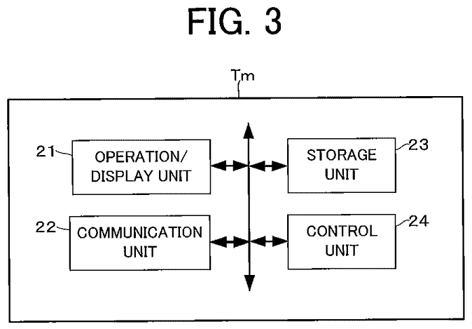

Next, a configuration and a function of the operator terminal Tm will be described with reference to FIG. 3. FIG. 3 is a diagram illustrating a schematic configuration example of the operator terminal Tm. The operator terminal Tm includes an operation/display unit 21, a communication unit 22, a storage unit 23, a control unit 24, and the like. As the operator terminal Tm, for example, a personal computer can be applied. The operator terminal Tm may include a voice processing unit and a speaker. The operation/display unit 21 has, for example, an input function for accepting input (selection) by a finger, pen, or mouse of the operator OPm, and a display function for displaying various screens on a display. Incidentally, the operator terminal Tm may be provided with a plurality of displays. The various screens include a login screen for the operator OPm to log in, a drone monitoring screen for the operator OPm to monitor the drone Dn, and an action request notification screen for notifying the operator OPm of a request for a predetermined action. Moreover, the drone monitoring screen and the action request notification screen should be displayed on separate displays at the same time.

The communication unit 22 controls communication performed via the communication network NW. The storage unit 23 includes a non-volatile memory or the like, and stores various programs (program code groups) and pieces of data. The various programs include an operating system (OS), a monitoring application, the GCS, and a web browser. The monitoring application is mainly a program for acquiring, from the management server MS, and displaying information regarding the plurality of the drones Dn for which the operator OPm is in charge. Incidentally, the monitoring application may be downloaded from a predetermined server to the operator terminal Tm.

The control unit 24 (an example of a computer) includes at least one CPU, a ROM, an RAM, and the like, and executes processing in accordance with the monitoring application stored in the ROM (or, the storage unit 23). When the monitoring application is activated in response to an instruction of the operator OPm, the control unit 24 displays the login screen on the display. Then, when a user ID and a password are input by the operator OPm through the login screen, the control unit 24 transmits a login request including the user ID and the password to the management server MS via the communication unit 22 and the communication network NW. The user ID is identification information for identifying the operator OPm.

Then, when the operator OPm logs in in response to the login request, display control data for displaying the drone list is transmitted from the management server MS, wherein the drone list indicates the plurality of the drones Dn for which the logged-in operator OPm is in charge. Thereby, the control unit 24 displays the drone monitoring screen including the drone list on the display. Incidentally, in the login processing, it is determined whether a set of the user ID and the password included in the login request is registered in a database. Then, when the set of the user ID and the password is registered, the operator OPm who uses the operator terminal Tm that has transmitted the login request is identified (identified by the user ID), and the operator OPm logs in.

Here, the plurality of the drones Dn indicated in the drone list may be under the control of the same drone base Bm, or may be under the control of different drone bases Bm. In the latter case, the drone list indicates the drones Dn (e.g., the drones D1 to D4 and drones D5 to D9) belonging to each of the plurality of the drone bases Bm (e.g., the drone base B1 and drone base B2). This allows the operator OPm to monitor each drone Dn under the control of the plurality of the drone bases Bm. Incidentally, the display control data may be data of a web page displayed by the web browser. The display control data of the drone monitoring screen may be incorporated into the monitoring application.

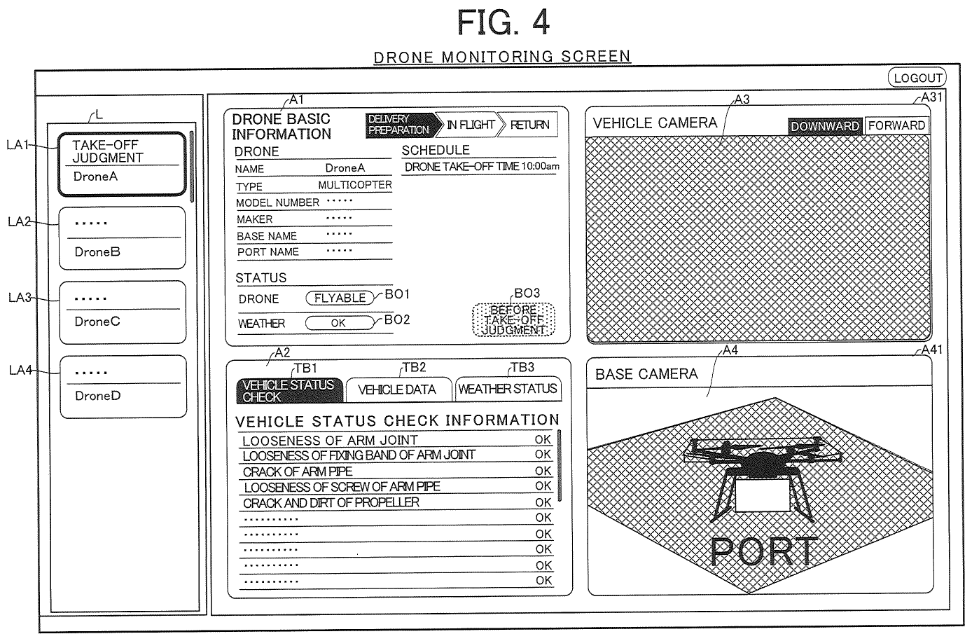

FIGS. 4 to 8 are a diagram illustrating a display example of the drone monitoring screen displayed on the operator terminal T1 of the operator OP1. As illustrated in FIGS. 4 to 8, a drone list L indicating (showing) the plurality of the drones D1 to D4 (the drone name: Drone A, Drone B, Drone C, Drone D) are displayed on the drone monitoring screen. Furthermore, a drone basic information display area A1, a drone detailed information display area A2, a vehicle camera display area A3, and a base camera display area A4 and the like are provided on the drone monitoring screen. The drone list L includes simple information display areas LA1 to LA4 corresponding to each of the drones D1 to D4 for which the operator OP1 is in charge. The simple information display areas LA1 to LA4 are scrollable. The names (the drone names) of the drones D1 to D4 are displayed on the simple information display areas LA1 to LA4. Incidentally, the drone list L may include simple information display areas corresponding to each of the drones D5 to D9 for which the operator OP1 is in charge.

Moreover, the simple information display areas LA1 to LA4 are selectable by the operator OP1. In other words, the drones D1 to D4 can be selected via the simple information display areas LA1 to LA4. In the display examples of FIGS. 4 to 8, since the drone D1 is in the selected state in response to selecting (pressing) of the simple information display area LA1 by the operator OP1, monitoring information (acquired from the management server MS as appropriate) for monitoring the drone D1 in the selected state is displayed in the drone basic information display area A1, the drone detailed information display area A2, the vehicle camera display area A3, and the base camera display area A4. Here, the monitoring information includes, for example, the manual inspection result information, the base image information, vehicle data information, the vehicle image information, the detailed weather information, and the like. Incidentally, in the display example of FIGS. 4 to 8, the drone D1 is placed in the port P1 for take-off at the drone base B1 and is in a state where it is waiting for the take-off judgment by the operator OP1.

The basic information of the drone D1, a vehicle status (hereinafter referred to as “drone status”) of the drone D1, a weather status of the drone base B1, and a drone schedule of the drone D1 are displayed in the drone basic information display area A1. Incidentally, the measurement information measured by the sensor provided with the base instrument Em may be displayed in the drone basic information display area A1. The basic information of the drone D1 includes, for example, drone name (i.e., name of the drone D1), type, model number, manufacturer (maker), base name (i.e., name of the drone base B1), and port name (name of port P1) of the drone D1, but is not particularly limited. The drone status of the drone D1 indicates what kind of state (situation) the drone D1 is currently. The weather status indicates, for example, the current state (situation) of the weather at the drone base B1 based on the detailed weather information. The drone schedule of the drone D1 includes, for example, a scheduled time of at least one of take-off of the drone D1 and arrival at a destination (e.g., arrival at a delivery destination).

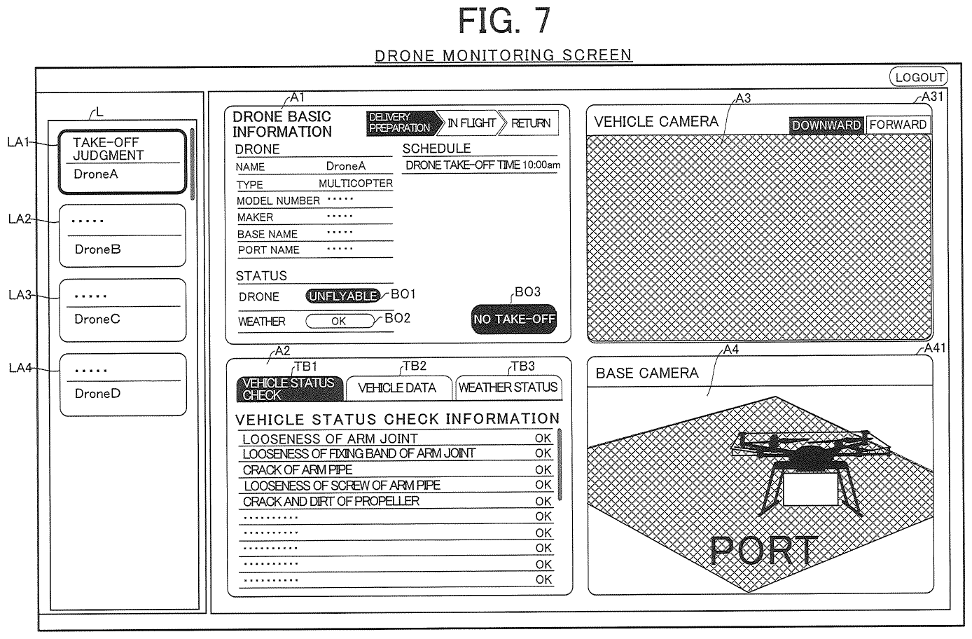

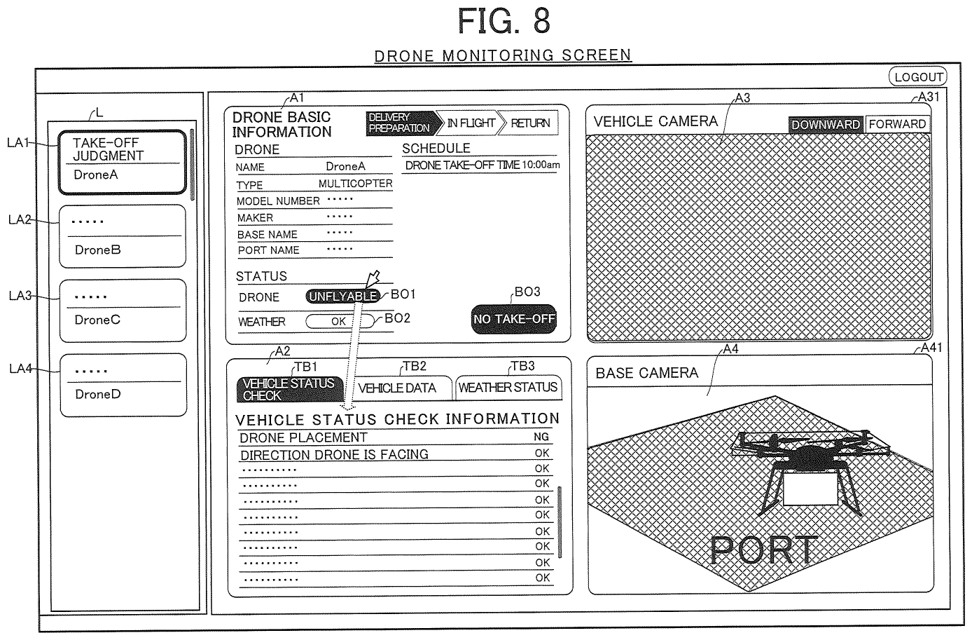

Furthermore, a drone status button BO1, a weather status button BO2, and a take-off judgment button BO3 are provided in the drone basic information display area A1. In the display example of FIGS. 4 to 6, “FLYABLE” is displayed as the drone status on the drone status button BO1. “FLYABLE” indicates that the drone D1 is ready for flight based on the condition of the drone D1. On the other hand, in the display examples of FIGS. 7 and 8, “UNFLYABLE” is displayed as the drone status on the drone status button BO1. “UNFLYABLE” indicates that the drone D1 is not ready for flight based on the condition (an abnormality occurred in the drone D1, an incorrect positioning of the drone D1, an incorrect direction of the drone D1, etc.) of the drone D1. The condition of the drone D1 may be determined based on the manual inspection result information or the automatic inspection result information. Moreover, in the display example of FIGS. 4 to 8, “OK” indicating a favorable weather (good weather) is displayed as the weather status on the weather status button BO2. The favorable weather indicates that the drone D1 is ready for flight based on the weather conditions. Incidentally, although not shown in FIGS. 4 to 8, “NG” indicating unfavorable weather (bad weather) may be displayed as the weather status on the weather status button BO2. The unfavorable weather indicates that the drone D1 is not ready for flight based on weather conditions (e.g. windy, heavy rainfall, etc.).

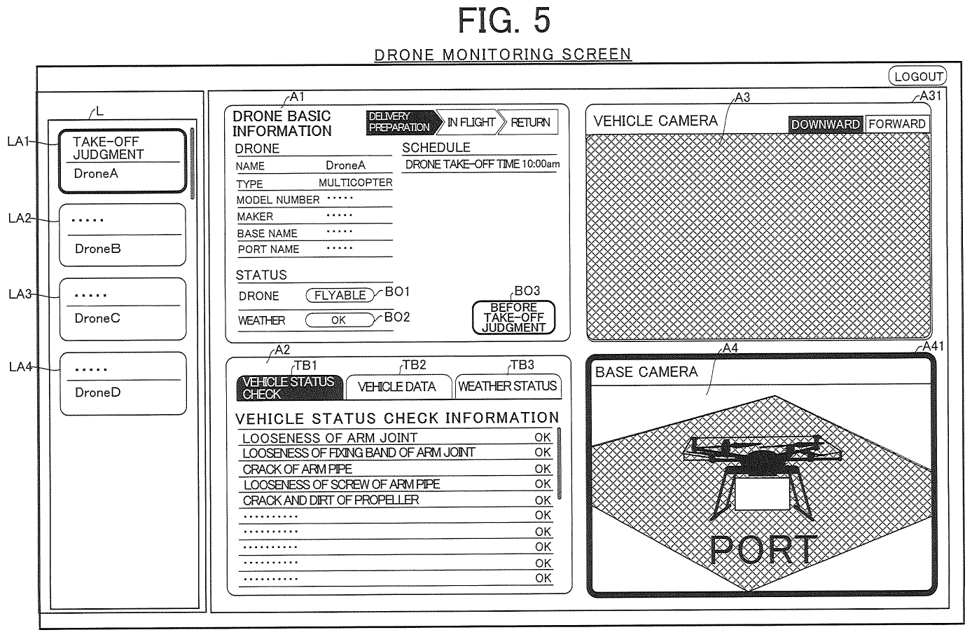

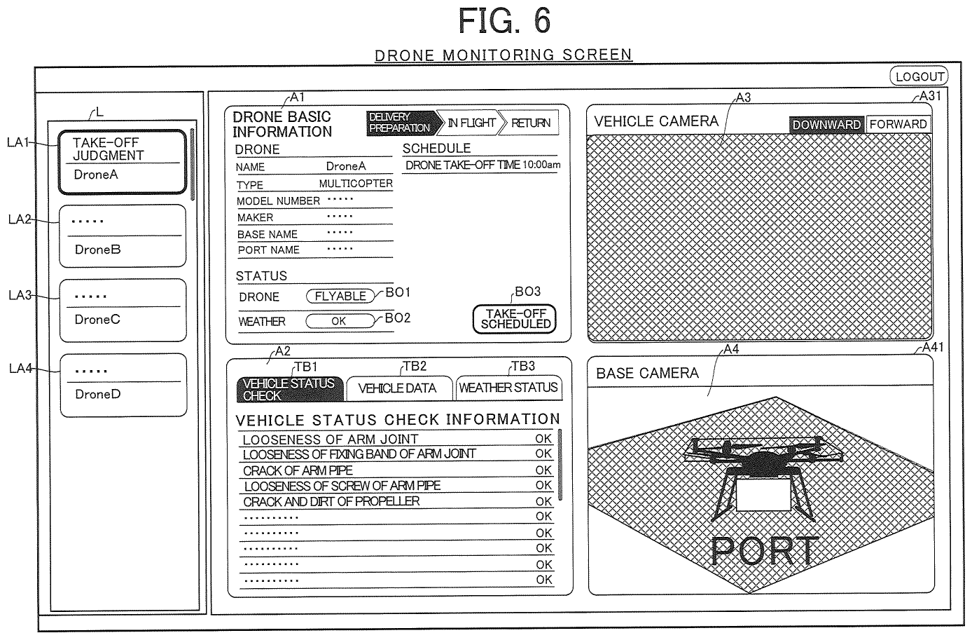

The take-off judgment button BO3 is an example of an operation button for accepting the take-off clearance for the drone D1 from the operator OP1. In the display example of FIG. 4, since it is before the judgment timing of the take-off clearance arrives, the take-off judgment button BO3 is grayed out and is disabled such that the take-off clearance cannot be accepted. That is, the operator OP1 cannot select (press) the take-off judgment button BO3. At this time, “BEFORE TAKE-OFF JUDGMENT” is displayed on the take-off judgment button BO3. In the display example of FIG. 5, since the judgment timing of the take-off clearance (e.g., a first judgment timing being 15 minutes before take-off) has arrived and the drone D1 is in a flight-ready state (a flight-capable state), the take-off judgment button BO3 is enabled such that a first take-off clearance can be accepted. That is, the operator OP1 can select the take-off judgment button BO3. At this time, “BEFORE TAKE-OFF JUDGMENT” is also displayed on the take-off judgment button BO3. In the state of the display example in FIG. 5, when the take-off judgment button BO3 is selected, the display on the take-off judgment button BO3 is changed as shown in FIG. 6. At this time, “TAKE-OFF SCHEDULED” is displayed on the take-off judgment button BO3. On the other hand, in the display examples of FIGS. 7 and 8, since the judgment timing of the take-off clearance has arrived, but the drone D1 is not in the flight-ready state, the take-off judgment button BO3 is disabled such that the take-off clearance cannot be accepted. At this time, “NO TAKE-OFF” (i.e., Take-off not possible) is displayed on the take-off judgment button BO3.

In the display examples of FIGS. 4 to 8, a vehicle status check tab TB1, a vehicle data tab TB2, and a weather status tab TB3 are provided in the drone detailed information display area A2. In these examples, the vehicle status check tab TB1 is selected and displayed among the tabs TB1 to TB3, and therefore the vehicle status check information (list) is displayed below the tabs TB1 to TB3. The vehicle status check information is based on the manual inspection result information. In the display examples of FIGS. 4 to 6, “OK” as displayed in association with the inspection item “LOOSENESS OF ARM JOINT”, which is included in the vehicle status check information, indicates for example, that the result of this manual inspection (vehicle status check) is fine (good). Incidentally, if the result of this manual inspection is not fine (i.e., poor), it will be associated with the inspection item, for example, “NG” will be displayed.

On the other hand, when the vehicle data tab TB2 is selected by the operator OP1 in the drone detailed information display area A2, the vehicle data information (list) is displayed below the tabs TB1 to TB3. The vehicle data information is based on the battery information (the remaining battery capacity), the capture number information (satellite capture number), and the like. Moreover, when the weather status tab TB3 is selected by the operator OP1 in the drone detailed information display area A2, the detailed weather information of the drone base B1 is displayed below the tabs TB1 to TB3. Incidentally, the tabs TB1 to TB3 can be manually selected by the operator OP1, respectively. Moreover, the tabs TB1 to TB3 can be automatically selected (i.e., switched) in response to the selection of the drone status button BO1 showing “UNFLYABLE” or the weather status button BO2 showing “NG”. Moreover, when the drone status button BO1 or the weather status button BO2 is selected, the tabs TB1 to TB3 may be switched regardless of the drone status.

For example, when the drone status button BO1 showing “UNFLYABLE” is selected while the vehicle status check tab TB1 is selected as shown in FIG. 7, the inspection item “DRONE PLACEMENT” (i.e., a place where the drone is placed) with a poor result (no good result) is displayed in the vehicle status check information as shown in FIG. 8. That is, it is transitioned to the display area where the operator OP1 can confirm the factor that the drone D1 is not in the flight-ready state. This enables the operator OP1 to quickly identify which inspection item has “NG” result. On the other hand, for example, when the drone status button BO1 showing “UNFLYABLE” is selected while the vehicle data tab TB2 is selected, it may be switched to the vehicle status check tab TB1 (i.e., so that the operator OP1 can confirm the factor that the drone D1 is not in the flight-ready state), and an inspection item with a poor result may be displayed in the vehicle status check information. Incidentally, when the weather status button BO2 showing “NG” is selected while the vehicle status check tab TB1 is selected, it is switched to the weather status tab TB3, and the detailed weather information of the drone base B1 is displayed.

In the display example of FIG. 5, the moving image (hereinafter referred to as “vehicle camera video”) captured by the vehicle camera of the drone D1 is displayed in the vehicle camera display area A3. On the other hand, the moving image (hereinafter referred to as “base camera video”) captured by the base camera of the base instrument E1 is displayed in the base camera display area A4. In this example, since the first judgment timing of the take-off clearance has arrived and the drone D1 is in the flight-ready state, the base camera video is highlighted so as to prompt the operator OP1 to confirm (check) the base camera video. For example, the frame A41 of the base camera display area A4 is displayed in red (from in black). At this time, the vehicle camera video may be highlighted along with the base camera video. The highlighting includes displaying in a conspicuous (prominent) display manner (e.g., display color, display size, display mode, etc.). In particular, highlighting of images may include displaying the frame of the display area of the images in a conspicuous display mode (e.g., displaying the frame in a more prominent color than usual, displaying the frame thicker than usual, or displaying the frame to flash). Alternatively, highlighting of images may include displaying an attention message (for example, a character string) in the display area of the images. Incidentally, in addition to the base camera video, the basic information of the drone D1 may be highlighted.

When the operator OP1 selects (presses) the take-off judgment button BO3 showing “BEFORE TAKE-OFF JUDGMENT” in a case where the first judgment timing of the take-off clearance has arrived and the drone D1 is in the flight-ready state, a pop-up screen (not shown) with OK (yes) button and NG (no) button is displayed on the drone monitoring screen. When the OK button displayed on the pop-up screen is selected by the operator OP1, the first take-off clearance is received by the control unit 24, and take-off clearance information indicating the take-off clearance is transmitted to the management server MS. In this manner, when the take-off clearance of the drone D1 is accepted via the take-off judgment button BO3 showing “BEFORE TAKE-OFF JUDGMENT”, the display on the take-off judgment button BO3 switches to “TAKE-OFF SCHEDULED”, and the highlighting of the base camera video and the like are stopped. Incidentally, when the take-off judgment button BO3 showing “BEFORE TAKE-OFF JUDGMENT” is displayed on the drone monitoring screen, the monitoring information including the information (e.g., the drone name) of the drone D1 to be monitored may be displayed on the action request notification screen together with the information prompting the operator OP1 to make the take-off judgment. Thereafter, the drone D1 will continue to be ready for flight, and when a predetermined time has elapsed and a final judgment (final take-off judgment) timing of the take-off clearance has arrived, a final take-off clearance can be accepted.

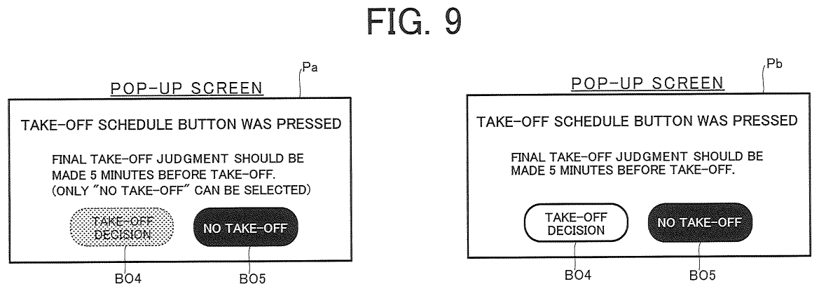

Here, the final take-off clearance may be performed, for example, on the pop-up screen displayed by selecting the take-off judgment button BO3 showing “TAKE-OFF SCHEDULED”, as shown in FIG. 6. FIG. 9 is a diagram illustrating an example of the pop-up screen displayed when the take-off judgment button BO3 showing “TAKE-OFF SCHEDULED” is selected. A take-off decision button BO4 displayed in each of the pop-up screens Pa and Pb as illustrated in FIG. 9, is an example of an operation button for accepting the take-off clearance of the drone D1 from the operator OP1. A take-off decision button BO4 displayed on the pop-up screen Pa as illustrated in FIG. 9, is grayed out and disabled so as not to be able to accept the final take-off clearance. This is because the final judgment timing of the take-off clearance has not arrived.

On the other hand, the take-off decision button BO4 displayed on the pop-up screen Pb as illustrated in FIG. 9, is enabled to be able to accept the final take-off clearance. This is because the final judgment timing of the take-off clearance has arrived and the drone D1 is in the flight-ready state. Incidentally, a non-take-off button BO5 displayed on each of the pop-up screens Pa and Pb is displayed as selectable. When the final judgment timing of the take-off clearance arrives in the case where the drone D1 is ready for flight, the base camera video and the like may be highlighted again so as to prompt the operator OP1 to confirm the base camera video and the like. Then, when the take-off decision button BO4 displayed on the pop-up screen Pb as illustrated in FIG. 9, is selected by the operator OP1, the take-off clearance information is transmitted to the management server MS, the GCS or the drone D1. As a result, drone D1 will take off from the port P1. Incidentally, if there is the manipulator of the drone D1, when the take-off decision button BO4 displayed on the pop-up screen Pb as illustrated in FIG. 9, is selected by the operator OP1, the manipulator terminal used by the manipulator may be notified of the take-off clearance.

### 1-3. Configuration and Function of Management Server MS

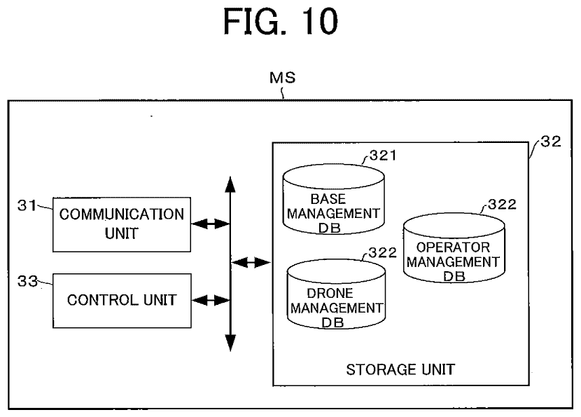

Next, a configuration and a function of the management server MS will be described with reference to FIG. 10. FIG. 10 is a diagram illustrating a schematic configuration example of the management server MS. As illustrated in FIG. 10, the management server MS includes a communication unit 31, a storage unit 32, a control unit 33, and the like. The communication unit 31 controls communication performed via the communication network NW. The manual inspection result information, the base image information, the measurement information, and the base ID of the drone base Bm, all of which are transmitted from the base instrument Em, are received by the communication unit 31. The battery information, the capture number information, the vehicle image information, the position information of the drone Dn, the automatic inspection result information, and the vehicle ID of the drone Dn, all of which are transmitted from drone Dn, are received by the communication unit 31. The management server MS can recognize the current position of the drone Dn based on the position information of the drone Dn. Moreover, the login request transmitted from the operator terminal Tm is received by the communication unit 31. Moreover, the detailed weather information transmitted from the weather management server is received by the communication unit 31.

The storage unit 32 includes, for example, a hard disk drive or the like, and stores an operating system, various programs including an application, and the like. Here, the application includes a program for executing a control method. The program may be stored in a non-transitory computer readable memory. Furthermore, a base management database (DB) 321, a drone management database (DB) 322, and an operator management database (DB) 323 are constructed in the storage unit 32. The base management database 321 is a database for managing information on the drone base Bm.

In the base management database 321, for example, the base ID of the drone base Bm, the base image information, the measurement information, the detailed weather information, the weather status, the vehicle ID of the drone Dn under the control of the drone base Bm, and the like are stored in association with each drone base Bm. Incidentally, the base image information, the measurement information, and the detailed weather information may be appropriately updated each time they are received by the communication unit 31. Moreover, the weather status is appropriately updated according to the detailed weather information.

The drone management database 322 is a database for managing information on the drone Dn. In the drone management database 322, the vehicle ID (drone ID), the position information, the basic information, the drone status, the drone schedule, the manual inspection result information, the vehicle data information, the vehicle image information, and the like are stored in association with each drone Dn. The vehicle data information includes, for example, the battery information, the capture number information, and the like. Incidentally, the manual inspection result information, the vehicle data information, the vehicle image information may be appropriately updated each time they are received by the communication unit 31. Moreover, the drone status is updated appropriately based on, for example, the manual inspection result information or the automatic inspection result information received by the communication unit 31.

The operator management database 323 is a database for managing information on the operator OPm. In the operator management database 323, the user ID of the operator OPm, the password of the operator OPm, a login status, the vehicle ID of each of the plurality of the drones Dn for which the operator OPm is in charge, a name of the operator OPm, and the like are stored in association with each operator OPm. Here, the login status indicates whether the operator OPm logs in.

The control unit 33 (an example of a computer) includes at least one CPU, a ROM, an RAM, and the like, and performs various processes according to the programs (program code) stored in the ROM, the storage unit 32, or the non-transitory computer readable memory. The CPU (an example of processor) is configured to access the program code stored in the ROM, the storage unit 32, or the non-transitory computer readable memory and operate as instructed by the program code. The program code includes: display control code configured to cause the CPU to display an operation button for accepting the take-off clearance for the drone Dn from the operator OPm on the screen of the operator terminal Tm; first determination code configured to cause the CPU to determine whether the judgment timing has arrived; and button control code configured to cause the CPU to control the operation button such that the take-off clearance is unacceptable from the operator OPm before the judgment timing arrives, and to control the operation button such that the take-off clearance is acceptable from the operator OPm when the drone Dn is in the flight-ready state after the judgment timing arrives. Moreover, the program code further may include: first identification code configured to cause the CPU to identify the drone status of the drone Dn; and second determination code configured to cause the CPU to determine, based on the identified drone status, whether the drone Dn is in the flight-ready state. Moreover, the program code further may include: second identification code configured to cause the CPU to identify the weather status in the base Bm where the drone Dn is allowed to take off or land; and third determination code configured to cause the CPU to determine, based on the identified weather status, whether the drone Dn is in the flight-ready state. Moreover, the program code further may include fourth determination code configured to determine whether there is any abnormality by analyzing at least one of the vehicle image (an example of first image) and the base image (an example of second image), in response to arrival of the judgment timing. Incidentally, the processor may be implemented using circuitry or processing circuitry which includes general purpose processors, special purpose processors, integrated circuits, ASICs, conventional circuitry and/or combinations thereof which are configured or programmed to perform the disclosed functionality. The processor may be hardware (or a combination of hardware and software) that carry out or are programmed to perform the recited functionality.

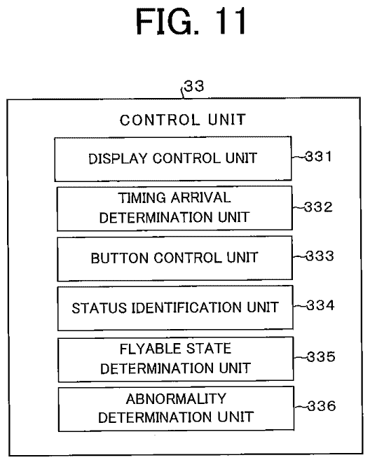

FIG. 11 is a diagram illustrating an example of functional blocks in the control unit 33. The control unit 33 functions a display control unit 331, a timing arrival determination unit 332, a button control unit 333, a status identification unit 334, a flyable state determination unit 335, an abnormality determination unit 336, and the like as illustrated in FIG. 11, in accordance with the program (the program code) stored in the ROM, the storage unit 32, or the non-transitory computer readable memory.

The display control unit 331 generates the drone list indicating, for example, the plurality of the drones Dn for which the logged-in operator OPm is in charge. Then, the display control unit 331 transmits, to the operator terminal Tm of the operator OPm, display control data for displaying the generated drone list. As a result, the drone list is displayed on the drone monitoring screen of the operator terminal Tm. When any drone Dn is selected from the drone list by the operator OPm, its selection request (including the vehicle ID of the selected drone Dn) is transmitted to the management server MS and received by the communication unit 31.

Then, in response to the selection request from the operator OPm, the display control unit 331 transmits, to the operator terminal Tm of the operator OPm, display control data for displaying the monitoring information for the selected drone Dn and the take-off judgment button BO3 and the like. As a result, the monitoring information, the take-off judgment button BO3, and the like are displayed on the drone monitoring screen of the operator terminal Tm. This enables the operator OPm to quickly input the take-off judgment result (e.g., take-off clearance) by the take-off judgment button BO3 while looking at the monitoring information of the drone Dn. Incidentally, the drone Dn may be automatically selected according to the drone status of the drone Dn. In this case, the monitoring information for the selected drone Dn, the take-off judgment button BO3, and the like may be automatically displayed on the drone monitoring screen.

The timing arrival determination unit 332 determines, at a predetermined time interval, whether the judgment timing of the take-off clearance for the drone Dn by the operator OPm has arrived (i.e., whether the current time is the judgment timing). The judgment timing of the take-off clearance may be set, for example, T1 (e.g., 15) minutes before the scheduled take-off time. Moreover, as described above, the judgment timings of the take-off clearance may be set in two or more stages, such as the first judgment timing (e.g., T1 minute before the scheduled take-off time) and the final judgment timing (e.g., T2 (e.g., 5) minutes before the scheduled take-off time (T1>T2)). Here, T1 and T2 may be set based on the time required for the operator OPm to judge the take-off clearance, for example.

Alternatively, the operator OPm may perform, in addition to judging of the take-off clearance, tasks such as specifying the flight route of the drone Dn and communicating with the manipulator of the drone Dn. Therefore, the judgment timings (e.g., T1, T2) may be set based on the time required for the tasks in addition to the time required to judge the take-off clearance. In this case, the first judgment timing is set to be longer than T1, such as, for example, T3 (e.g., 25) minutes before the scheduled take-off time. Incidentally, information indicating the tasks and the time required for the tasks may be stored in the operator management database 323 in association with the user ID of the operator OPm.

The button control unit 333 controls (for example, disables) the take-off judgment button BO3 (in the case of the final judgment timing, the take-off decision button BO4) such that the take-off clearance for the selected drone Dn is unacceptable from the operator OPm before the judgment timing of the take-off clearance for the selected drone Dn arrives in accordance with the arrival determination of the judgment timing by the timing arrival determination unit 332. Meanwhile, the button control unit 333 controls (e.g., enables) the take-off judgment button BO3 (in the case of the final judgment timing, the take-off decision button BO4) such that the take-off clearance for the selected drone Dn is acceptable from the operator OPm when the selected drone Dn is in the flight-ready state after the judgment timing of the take-off clearance for the selected drone Dn arrives in accordance with the arrival determination of the judgment timing by the timing arrival determination unit 332. Incidentally, the flyable state determination unit 335 determines whether the drone Dn is in the flight-ready state, as described below.

For example, in a case where the take-off judgment button BO3 corresponding to the selected drone Dn is displayed on the drone monitoring screen before the first judgment timing of the take-off clearance for the selected drone Dn arrives (see FIG. 4), the button control unit 333 may disable the take-off judgment button BO3 by setting disabling control data for disabling the take-off judgment button BO3 in the display control data. At this time, the display control unit 331 may transmit the display control data for graying out the take-off judgment button BO3 as shown in FIG. 4 to the operator terminal Tm. Moreover, in a case where the take-off decision button BO4 corresponding to the selected drone Dn is displayed on the drone monitoring screen before the final judgment timing of the take-off clearance for the selected drone Dn arrives (see FIG. 9), the button control unit 333 may disable the take-off decision button BO4 by setting disabling control data for disabling the take-off decision button BO4 in the display control data. At this time, the display control unit 331 may transmit the display control data for graying out the take-off decision button BO4 as shown in the pop-up screen Pa of FIG. 9 to the operator terminal Tm.

On the other hand, in a case where the take-off judgment button BO3 corresponding to the selected drone Dn is displayed on the drone monitoring screen after the first judgment timing of the take-off clearance for the selected drone Dn arrives, and the selected drone Dn is in the flight-ready state (see FIG. 5), the button control unit 333 may enable the take-off judgment button BO3 by setting enabling control data for enabling the take-off judgment button BO3 in the display control data. Moreover, in a case where the take-off judgment button BO3 corresponding to the selected drone Dn is displayed on the drone monitoring screen (see FIG. 4), and the selected drone Dn is in the flight-ready state (see FIG. 5) after the first judgment timing of the take-off clearance for the selected drone Dn arrives, the button control unit 333 may enable the take-off judgment button BO3 by transmitting enabling control data for enabling the take-off judgment button BO3 to the operator terminal Tm.

Moreover, in a case where the take-off decision button BO4 corresponding to the selected drone Dn is displayed on the drone monitoring screen after the final judgment timing of the take-off clearance for the selected drone Dn arrives, and the selected drone Dn is in the flight-ready state (see FIG. 9), the button control unit 333 may enable the take-off decision button BO4 by setting enabling control data for enabling the take-off decision button BO4 in the display control data. Moreover, in a case where the take-off decision button BO4 corresponding to the selected drone Dn is displayed on the drone monitoring screen (see FIG. 4), the selected drone Dn is in the flight-ready state (see FIG. 9) after the final judgment timing of the take-off clearance for the selected drone Dn arrives, the button control unit 333 may enable the take-off decision button BO4 by transmitting enabling control data for enabling the take-off decision button BO4 to the operator terminal Tm.

Moreover, in a case where the take-off judgment button BO3 (or the take-off decision button BO4) is controlled to be able to accept the take-off clearance for the selected drone Dn (i.e., when the take-off judgment button BO3 or the take-off decision button BO4 is enabled), the display control unit 331 may transmit, to the operator terminal Tm, display control data for highlighting the images to prompt the operator OPm to confirm at least one of the vehicle image (e.g., vehicle camera video) and the base image (e.g., base camera video). This makes it possible to quickly inform the operator OPm that the timing for making a take-off judgement has arrived.

For example, the frame A41 of the base camera display area A4 that displays the base camera video is displayed in red (for example, changing from black to red). Then, when the take-off judgment button BO3 (or the take-off decision button BO4) is selected by the operator OPm, the take-off clearance information is transmitted to the management server MS and received by the communication unit 31. In this manner, when the take-off clearance for the selected drone Dn is accepted via the take-off judgment button BO3 (or the take-off decision button BO4), the display control unit 331 may transmit highlighting stop control data for stopping the highlighting of the images to the operator terminal Tm. This makes it possible to quickly inform the operator OPm that the take-off clearance has been accepted.

The status identification unit 334 identifies the current drone status (e.g., flyable or unflyable) of the selected drone Dn, for example, from the drone management database 322. Moreover, the status identification unit 334 identifies the current weather status (e.g., good weather or bad weather) of the drone base Bm to which the selected drone Dn belongs, for example, from the base management database 321. The flyable state determination unit 335 determines, based on at least one of the drone status identified by the status identification unit 334 and the weather status identified by the status identification unit 334, whether the selected drone Dn is in the flight-ready state. This makes it possible to accurately determine, in light of the drone status or the weather status, whether the drone Dn can fly. For example, when the drone status indicates “Flyable”, it is determined that the selected drone Dn is in the flight-ready state. Alternatively, when the drone status indicates “Flyable” and the weather status indicates “OK (good weather)”, it is determined that the selected drone Dn is in the flight-ready state.

When it is determined that the selected drone Dn is not in the flight-ready state based on the drone status by the flyable state determination unit 335, the display control unit 331 may transmit, to the operator terminal Tm, display control data for displaying information indicating a factor determined to be not in the flight-ready state. As a result, for example, as shown in FIG. 8, the information indicating the factor determined to be not in the flight-ready state is displayed on the drone monitoring screen of the operator terminal Tm. That is, the information indicating the factor is displayed on the drone monitoring screen in response to the selection of the drone status button BO1 showing “UNFLYABLE”. This makes it possible to quickly inform the operator OPm of what vehicle factors prevent the drone Dn from flying. Incidentally, even if the drone status button BO1 showing “UNFLYABLE” is not selected, the information indicating the factor determined to be not in the flight-ready state may be displayed on the drone monitoring screen (e.g., transition to a display area where the factor not in the flight-ready state can be confirmed).

Moreover, when it is determined that the selected drone Dn is not in the flight-ready state based on the weather status by the flyable state determination unit 335, the display control unit 331 may transmit, to the operator terminal Tm, display control data for displaying the detailed weather information of the drone base Bm to which the selected drone Dn belongs. As a result, for example, the detailed weather information of the drone base Bm to which the selected drone Dn belongs is displayed on the drone monitoring screen. That is, the detailed weather information is displayed on the drone monitoring screen in response to the selection of the weather status button BO2 showing “NG”. This makes it possible to quickly inform the operator OPm of what kind of bad weather prevent the drone Dn from flying. Incidentally, even if the weather status button BO2 showing “NG” is not selected, the detailed weather information of the drone base Bm to which the drone Dn may be displayed on the drone monitoring screen (e.g., transition to a display area where the detailed weather information can be confirmed).

The abnormality determination unit 336 determines whether there is any abnormality by analyzing at least one of the vehicle image of the selected drone Dn and the base image of the drone base Bm to which the selected drone Dn belongs, in response to arrival of the judgment timing of the take-off clearance (i.e., when it is determined by the timing arrival determination unit 332 that the judgment timing has arrived). For example, the abnormality determination unit 336 determines that there is the abnormality (e.g., an abnormality in transmission of the images) when brightness of the vehicle image or the base image is equal to or less than a threshold value (e.g., black (i.e., minimum brightness)). Alternatively, the abnormality determination unit 336 checks presence or absence of an airframe outwardly expressing a drone by analyzing the base image (for example, the base camera video) of the drone base Bm, and determines that there is the abnormality when the airframe cannot be detected from the base image (i.e., when the airframe does not appear in the base image). Here, the presence or absence of the airframe may be checked based on the pre-registered airframe appearance image (which may be a feature point).

When it is determined that there is the abnormality by the abnormality determination unit 336, the display control unit 331 may transmit, to the operator terminal Tm, display control data for highlighting the image that is determined to have the abnormality among the vehicle image and the base image so as to indicate to the operator OPm that there is the abnormality. This makes it possible to quickly inform the operator OPm that there is any abnormality with respect to the drone Dn by analyzing at least one of the vehicle image and the base image. It is preferable that the highlighting in this case is different from the highlighting in the case where the take-off judgment button BO3 (or the take-off decision button BO4) is controlled to be able to accept the take-off clearance for the drone Dn. For example, when it is determined that there is the abnormality by analysis of the base camera video, the frame A41 of the base camera display area A4 that displays the base camera video may be displayed to flash in red (for example, changing from black to red).

On the other hand, when it is determined by the abnormality determination unit 336 that there is not the abnormality, the display control unit 331 causes the operator terminal Tm to display at least one of the vehicle image and the base image so as to indicate to the operator OPm that there is no abnormality. This makes it possible to quickly inform the operator OPm that there is no abnormality with respect to the drone Dn from the analysis of at least one of the vehicle image and the base image. For example, the frame A31 of the vehicle camera display area A3 that displays the vehicle camera video and the frame A41 of the base camera display area A4 that displays the base camera video may be displayed in yellow (for example, changing from black to yellow).

### 2. Operation of Remote Monitoring System S

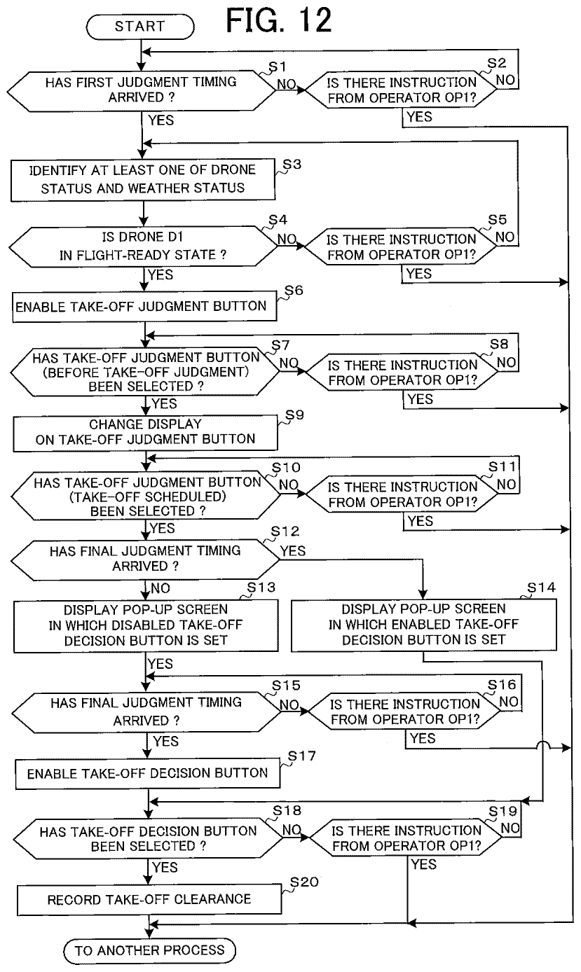

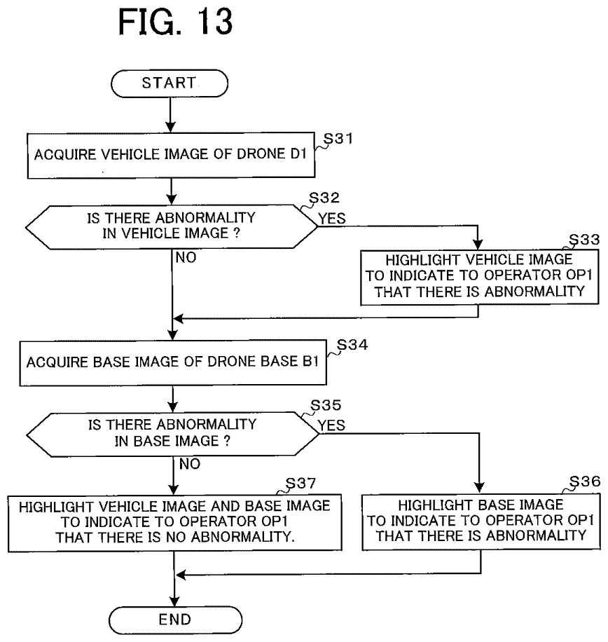

Next, an operation of the remote monitoring system S will be described with reference to FIGS. 12 and 13. FIG. 12 is a flowchart illustrating an example of a monitoring information display processing executed by the control unit 33 of the management server MS. FIG. 13 is a flowchart illustrating an example of an abnormality determination processing executed by the control unit 33 of the management server MS. As a premise of the following description of the operation example, the operator OP1 of the operator terminal T1 is logged in, the plurality of the drones Dn for which the logged-in operator OP1 is in charge are identified, and the drone monitoring screen including the drone list indicating the identified plurality of the drones Dn is already displayed on the operator terminal T1. When the operator OP1 logs in in this way, the management server MS continuously recognizes (monitors) a display state (including the display content of the monitoring information) of the drone monitoring screen in the operator terminal T1.

### 2.1. Monitoring Information Display Processing

First, the monitoring information display processing illustrated in FIG. 12 is started, for example, when the monitoring information of the drone Dn selected from the drone list by the operator OP1 is displayed on the drone monitoring screen. Incidentally, for convenience of explanation, it is assumed that the drone D1, for which the first judgment timing of the take-off clearance has not yet arrived, is selected by the operator OP1. As a result, as shown in FIG. 4, the monitoring information of the drone D1 is displayed, and the take-off judgment button BO3 (showing “BEFORE TAKE-OFF JUDGMENT”) is disabled.

The processing illustrated in FIG. 12 is started, the control unit 33 determines, by the timing arrival determination unit 332, whether the first judgment timing has arrived (step S1). When it is determined that the first judgment timing has not arrived (step S1: NO), the process proceeds to step S2. On the other hand, when it is determined that the first judgment timing has arrived (e.g., the current time is 15 minutes before the scheduled take-off time) (step S1: YES), the process proceeds to step S3.

In step S2, the control unit 33 determines whether a predetermined instruction has been received from the operator OP1 (i.e., there is a predetermined instruction from the operator OP1). Here, examples of predetermined instructions include a selection instruction for another drone Dn in the drone list, a selection instruction for buttons BO1 and BO2 shown in FIG. 4, a selection instruction for tabs TB1 to TB3 shown in FIG. 4, and a logout instruction. When it is determined that the predetermined instruction has not been received from the operator OP1 (step S2: NO), the process returns to step S1. At this time, after a predetermined waiting time (e.g., 30 seconds) has elapsed, the process may return to step S1. On the other hand, when it is determined that the predetermined instruction has been received from the operator OP1 (step S2: YES), another process is performed. Here, the other process is a process (e.g., display process) according to the predetermined instruction.

In step S3, the control unit 33 identifies, by the status identification unit 334, at least one of the current drone status of the drone D1 and the current weather status of the drone base B1 of the drone D1. Next, the control unit 33 determines, by the flyable state determination unit 335, whether the drone D1 is in the flight-ready state based on at least any one of the drone status and the weather status identified in step S3 (step S4). When it is determined that the drone D1 is not in the flight-ready state (step S4: NO), the process proceeds to step S5. On the other hand, when it is determined that the drone D1 is in the flight-ready state (step S4: YES), the process proceeds to step S6.

Incidentally, when it is determined in step S4 that the drone D1 is not in the flight-ready state based on the drone status, as described above, the display control unit 331 may cause the information indicating the factor determined to be not in the flight-ready state to be displayed on the drone monitoring screen. Moreover, when it is determined that the drone D1 is not in the flight-ready state based on the weather status, as described above, the display control unit 331 may cause the detailed weather information of the drone base B1 of the drone D1 to be displayed on the drone monitoring screen.

In step S5, the control unit 33 determines whether a predetermined instruction has been received from the operator OP1, similarly to step S2. When it is determined that the predetermined instruction has not been received from the operator OP1 (step S5: NO), the process returns to step S3. At this time, after a predetermined waiting time (e.g., 30 seconds) has elapsed, the process may return to step S3. On the other hand, when it is determined that the predetermined instruction has been received from the operator OP1 (step S5: YES), another process is performed.

In step S6, the control unit 33 enables (activates), by the button control unit 333, the take-off judgment button BO3 (showing “BEFORE TAKE-OFF JUDGMENT”) that is displayed and the grayed out on the drone monitoring screen, and the process proceeds to step S7. For example, the button control unit 333 enables the take-off judgment button BO3 by transmitting enabling control data for enabling the take-off judgment button BO3 to the operator terminal T1. As a result, the gray-out of the take-off judgment button BO3 (showing “BEFORE TAKE-OFF JUDGMENT”) is eliminated, and the take-off clearance for the drone D1 can be accepted. When the take-off judgment button BO3 (showing “BEFORE TAKE-OFF JUDGMENT”) is enabled in this way, as described above, the display control unit 331 may cause the operator terminal Tm to highlight the images so as to prompt the operator OP1 to confirm at least one of the vehicle image and the base image.

In step S7, the control unit 33 determines whether the take-off judgment button BO3 (showing “BEFORE TAKE-OFF JUDGMENT”) has been selected. When it is determined that the take-off judgment button BO3 (showing “BEFORE TAKE-OFF JUDGMENT”) has not been selected (step S7: NO), the process proceeds to step S8. On the other hand, when the take-off judgment button BO3 (showing “BEFORE TAKE-OFF JUDGMENT”) has been selected by the operator OP1, the take-off clearance information is transmitted to the management server MS. Then, the control unit 33 determines that the take-off judgment button BO3 (showing “BEFORE TAKE-OFF JUDGMENT”) has been selected by receiving the take-off clearance information via the communication unit 31. When it is determined that the take-off judgment button BO3 (showing “BEFORE TAKE-OFF JUDGMENT”) has been selected (step S7: YES), the processing proceeds to step S9.

In step S8, the control unit 33 determines whether a predetermined instruction has been received from the operator OP1, similarly to step S2. When it is determined that the predetermined instruction has not been received from the operator OP1 (step S8: NO), the process returns to step S7. At this time, after a predetermined waiting time (e.g., 30 seconds) has elapsed, the process may return to step S7. On the other hand, when it is determined that the predetermined instruction has been received from the operator OP1 (step S8: YES), another process is performed.

In step S9, the control unit 33 causes the display on the take-off judgment button BO3 to be changed from “BEFORE TAKE-OFF JUDGMENT” to “TAKE-OFF SCHEDULED”, and the process proceeds to step S10. Such the change of the display is made, for example, by transmitting change control data for changing the display on the take-off judgment button BO3 from “BEFORE TAKE-OFF JUDGMENT” to “TAKE-OFF SCHEDULED” to the operator terminal T1. Incidentally, one or more images is highlighted to prompt confirmation of at least one image among the vehicle image and the base image in step S6, the control unit 33 causes highlighting of one or more images to be stopped. Such the stop of the highlighting is made, for example, by transmitting highlighting stop control data for stopping the highlighting of one or more images to the operator terminal T1.

In step S10, the control unit 33 determines whether the take-off judgment button BO3 (showing “TAKE-OFF SCHEDULED”) has been selected. When it is determined that the take-off judgment button BO3 (showing “TAKE-OFF SCHEDULED”) has not been selected (step S10: NO), the process proceeds to step S11. For example, when the take-off judgment button BO3 (showing “TAKE-OFF SCHEDULED”) has been selected by the operator OP1, the take-off clearance information is transmitted to the management server MS. Then, the control unit 33 determines that the take-off judgment button BO3 (showing “TAKE-OFF SCHEDULED”) has been selected by receiving the take-off clearance information via the communication unit 31. When it is determined that the take-off judgment button BO3 (showing “TAKE-OFF SCHEDULED”) has been selected (step S10: YES), the processing proceeds to step S12.

In step S11, the control unit 33 determines whether a predetermined instruction has been received from the operator OP1, similarly to step S2. When it is determined that the predetermined instruction has not been received from the operator OP1 (step S11: NO), the process returns to step S10. At this time, after a predetermined waiting time (e.g., 30 seconds) has elapsed, the process may return to step S10. On the other hand, when it is determined that the predetermined instruction has been received from the operator OP1 (step S11: YES), another process is performed.

In step S12, the control unit 33 determines, by the timing arrival determination unit 332, whether the final judgment timing has arrived. When it is determined that the final judgment timing has not arrived (step S12: NO), the process proceeds to step S13. On the other hand, when it is determined that the final judgment timing has arrived (step S12: YES), the process proceeds to step S14.

In step S13, the control unit 33 causes the pop-up screen Pa in which the disabled take-off decision button BO4 is set, to be displayed on the drone monitoring screen as shown in FIG. 9, and the process proceeds to step S15. Such the displaying of the disabled take-off decision button BO4 is made by transmitting display control data for displaying the pop-up screen Pa to the operator terminal Tm. On the other hand, in step S14, the control unit 33 causes the pop-up screen Pb in which the enabled take-off decision button BO4 is set, to be displayed on the drone monitoring screen as shown in FIG. 9, and the process proceeds to step S18.

In step S15, the control unit 33 determines, by the timing arrival determination unit 332, whether the final judgment timing has arrived. When it is determined that the final judgment timing has not arrived (step S15: NO), the process proceeds to step S16. On the other hand, when it is determined that the final judgment timing has arrived (step S15: YES), the process proceeds to step S17.

In step S16, the control unit 33 determines whether a predetermined instruction has been received from the operator OP1, similarly to step S2. When it is determined that the predetermined instruction has not been received from the operator OP1 (step S16: NO), the process returns to step S15. At this time, after a predetermined waiting time (e.g., 30 seconds) has elapsed, the process may return to step S15. On the other hand, when it is determined that the predetermined instruction has been received from the operator OP1 (step S16: YES), another process is performed.

In step S17, the control unit 33 enables, by the button control unit 333, the take-off decision button BO4, the process proceeds to step S18. For example, the button control unit 333 enables the take-off decision button BO4 by transmitting enabling control data for enabling the take-off decision button BO4 to the operator terminal T1. As a result, the gray-out of the take-off decision button BO4 is eliminated, and the final take-off clearance for the drone D1 can be accepted. When the take-off decision button BO4 is enabled in this way, as described above, the display control unit 331 may cause the operator terminal Tm to highlight one or more images so as to prompt the operator OP1 to confirm at least one of the vehicle image and the base image.

In step S18, the control unit 33 determines whether the take-off decision button BO4 has been selected. When it is determined that the take-off decision button BO4 has not been selected (step S18: NO), the process proceeds to step S19. For example, when the take-off decision button BO4 has been selected by the operator OP1, the take-off clearance information is transmitted to the management server MS. Then, the control unit 33 determines that the take-off decision button BO4 has been selected by receiving the take-off clearance information via the communication unit 31. When it is determined that the take-off decision button BO4 has been selected (step S18: YES), the processing proceeds to step S20.

In step S19, the control unit 33 determines whether a predetermined instruction has been received from the operator OP1, similarly to step S2. When it is determined that the predetermined instruction has not been received from the operator OP1 (step S19: NO), the process returns to step S18. At this time, after a predetermined waiting time (e.g., 30 seconds) has elapsed, the process may return to step S18. On the other hand, when it is determined that the predetermined instruction has been received from the operator OP1 (step S19: YES), another process is performed.

In step S20, the control unit 33 records the take-off clearance. Then, the control unit 33 transmits a take-off command to the drone D1, or notifies the take-off clearance to the manipulator terminal of the manipulator of the drone D1. Incidentally, when one or more the images were highlighted so as to prompt confirmation of at least one image among the vehicle image and the base image in step S17, the control unit 33 causes highlighting of one or more the images to be stopped.

Incidentally, even after the process of step S6, the control unit 33 may periodically or irregularly determine, based on at least any one of the drone status and the weather status, whether the drone D1 is in a flight-ready state. In this case, when it is determined that the drone D1 is not in the flight-ready state, the take-off judgment button BO3 (showing “BEFORE TAKE-OFF JUDGMENT”) is disabled, and the display on the take-off judgment button BO3 is changed to “NO TAKE-OFF” as shown in FIG. 7.

### 2.2. Abnormality Determination Processing

Next, the abnormality determination processing illustrated in FIG. 13 may be executed, for example, when it is determined that the first judgment timing has arrived (step S1: YES) in step S1 before the process of step S3 shown in FIG. 12.

When the abnormality determination processing illustrated in FIG. 13, is started, the control unit 33 acquires the vehicle image of the drone D1 (step S31). Next, the control unit 33 determines, by the abnormality determination unit 336, whether there is any abnormality in the vehicle image acquired in step S31 (step S32). When it is determined that there is the abnormality in the vehicle image (step S32: YES), the process proceeds to step S33. On the other hand, when it is determined that there is no abnormality in the vehicle image (step S32: NO), the process proceeds to step S34.

In step S33, the control unit 33 causes the vehicle image to be highlighted (e.g., the frame A31 of the vehicle camera display area A3 is displayed in red) so as to indicate to the operator OP1 that there is the abnormality. Such the highlighting of the vehicle image is made, for example, by transmitting, to the operator terminal T1, display control data for highlighting the vehicle image to indicate that there is the abnormality.

Incidentally, as another example of highlighting the vehicle image to indicate that there is the abnormality, a message indicating that there is the abnormality in the vehicle image may be displayed. Moreover, when it is determined that there is the abnormality in the vehicle image, the control unit 33 may change the drone status of the drone D1 to “ABNORMAL OCCURRENCE”, and update and register the changed drone status in association with the vehicle ID of the drone D1 in the drone management database 322. In this case, it is determined that the drone D1 is not in the flight-ready state in step S4 shown in FIG. 12.

In step S34, the control unit 33 acquires the base image of the drone base B1 of drone D1. Next, the control unit 33 determines, by the abnormality determination unit 336, whether there is any abnormality in the base image acquired in step 34 (step S35). When it is determined that there is the abnormality in the base image (step S35: YES), the process proceeds to step S36. On the other hand, when it is determined that there is no abnormality in the base image (step S35: NO), the process proceeds to step S37.

In step S36, the control unit 33 causes the base image to be highlighted (e.g., the frame A41 of the base camera display area A4 is displayed in red) so as to indicate to the operator OP1 that there is the abnormality. Such the highlighting of the base image is made, for example, by transmitting, to the operator terminal T1, display control data for highlighting the base image to indicate that there is the abnormality.

Incidentally, as another example of highlighting the base image to indicate that there is the abnormality, a message indicating that there is the abnormality in the base image may be displayed. Moreover, when it is determined that there is the abnormality in the base image, the control unit 33 may change the drone status of the drone D1 to “ABNORMAL OCCURRENCE”, and update and register the changed drone status in association with the vehicle ID of the drone D1 in the drone management database 322. In this case, it is determined that the drone D1 is not in the flight-ready state in step S4 shown in FIG. 12.

In step S37, the control unit 33 causes the vehicle image and the base image to be displayed (e.g., the frame A31 of the vehicle camera display area A3 and the frame A41 of the base camera display area A4 are displayed in yellow) so as to indicate to the operator OP1 that there is no abnormality. Such the displaying of the vehicle image and the base image is made, for example, by transmitting, to the operator terminal T1, display control data for displaying the vehicle image and the base image to indicate that there is no abnormality.

Incidentally, the abnormality determination processing illustrated in FIG. 13 may be executed before the process of step S14 when it is determined that the final judgment timing has arrived (step S12: YES) in step S12 shown in FIG. 12. Moreover, when it is determined that the final judgment timing has arrived (step S15: YES) in step S15 shown in FIG. 12, the abnormality determination processing illustrated in FIG. 13 may be executed before the process of step S17.

As described above, according to the embodiment, the management server MS displays, on the drone monitoring screen through operator terminal Tm, the operation button (e.g., the take-off judgment button BO3 or the take-off decision button BO4) for accepting the take-off clearance for the drone Dn from the operator OPm, and determines whether the judgment timing of the take-off clearance by the operator OPm has arrived. Then, the management server MS controls the operation button such that the take-off clearance is unacceptable from the operator OPm before the judgment timing of the take-off clearance arrives, and controls the operation button such that the take-off clearance is acceptable from the operator OPm when the drone Dn is in the flight-ready state after the judgment timing of the take-off clearance arrives. Therefore, it is possible to appropriately support the operator OPm who makes the take-off judgment in light of the pre-flight risk of each of the plurality of the drones Dn, to reduce the burden on the operator OPm, and prevent human error when the operator OPm makes the take-off judgment.

Incidentally, the above-described embodiment is one embodiment of the present invention, and the present invention is not limited to the above-described embodiment, changes from the above-described embodiment can be made on various configurations and the like within a scope not departing from the gist of the present invention, and such cases shall be also included in the technical scope of the present invention. In the above embodiment, instead of the management server MS, the operator terminal Tm (control unit 24), in accordance with the monitoring application, may display, on the drone monitoring screen, the operation button for accepting the take-off clearance for the drone Dn from the operator OPm, and determine whether the judgment timing of the take-off clearance by the operator OPm has arrived. Then, the operator terminal Tm (control unit 24) may control the operation button such that the take-off clearance is unacceptable from the operator OPm before the judgment timing of the take-off clearance arrives, and control the operation button such that the take-off clearance is acceptable from the operator OPm when the drone Dn is in the flight-ready state after the judgment timing of the take-off clearance arrives. In this case, the operator terminal Tm may execute the monitoring information display processing illustrated in FIG. 12 and the abnormality determination processing illustrated in FIG. 13, while acquiring necessary information from the management server MS as needed.

### Note

[1] An information processing device according to the present disclosure includes: a display control unit configured to display an operation button for accepting a take-off clearance for an unmanned aerial vehicle from an operator on a screen of a terminal used by the operator; a first determination unit configured to determine whether a judgment timing has arrived, the judgment timing being a timing at which the operator is to judge whether to perform the take-off clearance; and a button control unit configured to control the operation button such that the take-off clearance is unacceptable from the operator before the judgment timing arrives, and to control the operation button such that the take-off clearance is acceptable from the operator when the unmanned aerial vehicle is in a flight-ready state after the judgment timing arrives. This makes it possible to prevent human error when the operator makes the take-off judgment.
[2] The information processing device described in [1] above, further includes: a first identification unit configured to identify a vehicle status of the unmanned aerial vehicle; and a second determination unit configured to determine, based on the vehicle status identified by the first identification unit, whether the unmanned aerial vehicle is in the flight-ready state. This makes it possible to accurately determine, in light of the vehicle status, whether the unmanned aerial vehicle can fly.
[3] In the information processing device described in above, wherein the display control unit is configured to display, on the screen, information indicating a factor determined to be not in the flight-ready state in a case where it is determined, by the second determination unit, that the unmanned aerial vehicle is not in the flight-ready state. This makes it possible to quickly inform the operator of what vehicle factors prevent the unmanned aerial vehicle from flying.
[4] The information processing device described in [1] or [2] above, further includes: a second identification unit configured to identify a weather status in a base where the unmanned aerial vehicle is allowed to take off or land; and a third determination unit configured to determine, based on the weather status identified by the second identification unit, whether the unmanned aerial vehicle is in the flight-ready state. This makes it possible to accurately determine, in light of the weather status, whether the unmanned aerial vehicle can fly.
[5] In the information processing device described in [4] above, wherein the display control unit is configured to display, on the screen, a detailed information on weather in a base in a case where it is determined, by the third determination unit, that the unmanned aerial vehicle is not in the flight-ready state. This makes it possible to quickly inform the operator of what kind of bad weather prevent the unmanned aerial vehicle from flying.
[6] In the information processing device described in any one of [1] to [5] above, wherein the display control unit is configured to display, on the screen, the operation button and at least one of vehicle information acquired by the unmanned aerial vehicle and base information acquired by an instrument at the base where the unmanned aerial vehicle is allowed to take off or land. This allows the operator to quickly input a result of the take-off judgment by the operation button while showing, to the operator, at least one of the vehicle information and the base information.
[7] In the information processing device described in [6] above, wherein the vehicle information includes a first image captured by a first camera provided with the unmanned aerial vehicle, the base information includes a second image captured by a second camera provided with the instrument, and the display control unit is configured to highlight at least one of the first image and the second image so as to prompt the operator to confirm at least one of the first image and the second image in controlling the operation button such that the take-off clearance is acceptable from the operator. This makes it possible to quickly inform the operator that the timing for making a take-off judgement has arrived.
[8] In the information processing device described in [6] or [7] above, wherein the vehicle information includes a first image captured by a first camera provided with the unmanned aerial vehicle, the base information includes a second image captured by a second camera provided with the instrument, the information processing device further includes a fourth determination unit configured to determine whether there is any abnormality by analyzing at least one of the first image and the second image, in response to arrival of the judgment timing, and the display control unit is configured to highlight an image having the abnormality among the first image and the second image so as to indicate to the operator that there is the abnormality in a case where it is determined, by the fourth determination unit, that there is the abnormality. This makes it possible to quickly inform the operator that there is any abnormality with respect to the unmanned aerial vehicle by analyzing at least one of the first image and the second image.
[9] In the information processing device described in [8] above, wherein the display control unit is configured to display at least one of the first image and the second image so as to indicate to the operator that there is not the abnormality in a case where it is determined, by the fourth determination unit, that there is not the abnormality. This makes it possible to quickly inform the operator that there is no abnormality with respect to the unmanned aerial vehicle from the analysis of at least one of the first image and the second image.
[10] In the information processing device described in any one of [7] to [9] above, wherein the display control unit is configured to stop highlighting of at least one of the first image and the second image, in response to accepting the take-off clearance via the operation button. This makes it possible to quickly inform the operator that the take-off clearance has been accepted.
[11] A control method executed by one or more computers, according to the present disclosure, includes: displaying an operation button for accepting a take-off clearance for an unmanned aerial vehicle from an operator on a screen of a terminal used by the operator; determining whether a judgment timing has arrived, the judgment timing being a timing at which the operator is to judge whether to perform the take-off clearance; and controlling the operation button such that the take-off clearance is unacceptable from the operator before the judgment timing arrives, and to control the operation button such that the take-off clearance is acceptable from the operator when the unmanned aerial vehicle is in a flight-ready state after the judgment timing arrives.
[12] A program according to the present disclosure, is configured to cause a computer to: display an operation button for accepting a take-off clearance for an unmanned aerial vehicle from an operator on a screen of a terminal used by the operator; determine whether a judgment timing has arrived, the judgment timing being a timing at which the operator is to judge whether to perform the take-off clearance; and control the operation button such that the take-off clearance is unacceptable from the operator before the judgment timing arrives, and to control the operation button such that the take-off clearance is acceptable from the operator when the unmanned aerial vehicle is in a flight-ready state after the judgment timing arrives.

### REFERENCE SIGNS LIST

11 Power supply unit
12 Drive unit
13 Positioning unit
14 Communication unit
15 Sensor unit
16 Storage unit
17 Control unit
21 Operation/display unit
22 Communication unit
23 Storage unit
24 Control unit
31 Communication unit
32 Storage unit
33 Control unit
331 Display control unit
332 Timing arrival determination unit
333 Button control unit
334 Status identification unit
335 Flyable state determination unit
336 Abnormality determination unit
Dn Drone
Tm Operator terminal
MS Management server
Em Base instrument
S Remote monitoring system

What is claimed is:

1. An information processing device comprising:
at least one memory configured to store program code; and at least one processor configured to access the program code and operate as instructed by the program code, the program code including:
display control code configured to cause the at least one processor to display an operation button for accepting a take-off clearance for an unmanned aerial vehicle from an operator on a screen of a terminal used by the operator;
first determination code configured to cause the at least one processor to determine whether a judgment timing has arrived, the judgment timing being a timing at which the operator is to judge whether to perform the take-off clearance; and
button control code configured to cause the at least one processor to control the operation button such that the take-off clearance is unacceptable from the operator before the judgment timing arrives, and to control the operation button such that the take-off clearance is acceptable from the operator when the unmanned aerial vehicle is in a flight-ready state after the judgment timing arrives.

2. An information processing device according to claim 1, the program code further including:
first identification code configured to cause the at least one processor to identify a vehicle status of the unmanned aerial vehicle; and
second determination code configured to cause the at least one processor to determine, based on the identified vehicle status, whether the unmanned aerial vehicle is in the flight-ready state.

3. An information processing device according to claim 2, wherein the display control code is configured to cause the at least one processor to display, on the screen, information indicating a factor determined to be not in the flight-ready state in a case where it is determined that the unmanned aerial vehicle is not in the flight-ready state.

4. An information processing device according to claim 1, the program code further including:
second identification code configured to cause the at least one processor to identify a weather status in a base where the unmanned aerial vehicle is allowed to take off or land; and
third determination code configured to cause the at least one processor to determine, based on the identified weather status, whether the unmanned aerial vehicle is in the flight-ready state.

5. An information processing device according to claim 4, wherein the display control code is configured to cause the at least one processor to display, on the screen, a detailed information on weather in a base in a case where it is determined that the unmanned aerial vehicle is not in the flight-ready state.

6. An information processing device according to claim 1, wherein the display control code is configured to cause the at least one processor to display, on the screen, the operation button and at least one of vehicle information acquired by the unmanned aerial vehicle and base information acquired by an instrument at the base where the unmanned aerial vehicle is allowed to take off or land.

7. An information processing device according to claim 6, wherein the vehicle information includes a first image captured by a first camera provided with the unmanned aerial vehicle,
the base information includes a second image captured by a second camera provided with the instrument, and
the display control code is configured to cause the at least one processor to highlight at least one of the first image and the second image so as to prompt the operator to confirm at least one of the first image and the second image in controlling the operation button such that the take-off clearance is acceptable from the operator.

8. An information processing device according to claim 6, wherein the vehicle information includes a first image captured by a first camera provided with the unmanned aerial vehicle,
the base information includes a second image captured by a second camera provided with the instrument,
the program code further includes fourth determination code configured to determine whether there is any abnormality by analyzing at least one of the first image and the second image, in response to arrival of the judgment timing, and
the display control code is configured to cause the at least one processor to highlight an image having the abnormality among the first image and the second image so as to indicate to the operator that there is the abnormality in a case where it is determined that there is the abnormality.

9. An information processing device according to claim 8, wherein the display control code is configured to cause the at least one processor to display at least one of the first image and the second image so as to indicate to the operator that there is not the abnormality in a case where it is determined that there is not the abnormality.

10. An information processing device according to claim 7, wherein the display control code is configured to cause the at least one processor to stop highlighting of at least one of the first image and the second image, in response to accepting the take-off clearance via the operation button.

11. A control method executed by one or more computers comprising:
displaying an operation button for accepting a take-off clearance for an unmanned aerial vehicle from an operator on a screen of a terminal used by the operator;
determining whether a judgment timing has arrived, the judgment timing being a timing at which the operator is to judge whether to perform the take-off clearance; and
controlling the operation button such that the take-off clearance is unacceptable from the operator before the judgment timing arrives, and to control the operation button such that the take-off clearance is acceptable from the operator when the unmanned aerial vehicle is in a flight-ready state after the judgment timing arrives.

12. A non-transitory computer readable memory having stored thereon a program configured to cause a computer to:
display an operation button for accepting a take-off clearance for an unmanned aerial vehicle from an operator on a screen of a terminal used by the operator;
determine whether a judgment timing has arrived, the judgment timing being a timing at which the operator is to judge whether to perform the take-off clearance; and
control the operation button such that the take-off clearance is unacceptable from the operator before the judgment timing arrives, and to control the operation button such that the take-off clearance is acceptable from the operator when the unmanned aerial vehicle is in a flight-ready state after the judgment timing arrives.
